(19) United States
(12) Patent Application Publication
(10) Pub. No.: US 2012/0253755 A1
(43) Pub. Date: Oct. 4, 2012

(54) Method Of Obtaining The Age Quotient Of A Person

(76) Inventor: David P. Gobel, Springfield, VA (US)

(21) Appl. No.: 13/076,115

(22) Filed: Mar. 30, 2011

(51) Int. Cl. G06F 17/10

(52) U.S. Cl. 703/2

(57) ABSTRACT

A method of using a computer for providing an Age Quotient (AQ) which is similar to a FICO (credit worthiness) or IQ index that repeatably and reliably defines and describes a person's physical and biological age Vs. his/her chronological age comprises: recording an image of each face of a multiple number of people in a computer; assigning a reference numeral to each feature of a person's face; grouping the reference numerals into specific areas of data; using the data for each area to create a statistical model which includes a distribution curve normalized and cross correlated by a specific area of, for example, sex, race, ancestry, or genetics of each specific area; comparing the distribution curve(s) with a person's profile to identify a distribution curve which places that person's individual's profile at the mathematically appropriate standard deviation from the normal distribution; and assigning the center of the distribution curve to be the standard where chronological age is deemed to equal Somatic age.

### BACKGROUND OF THE INVENTION

1. Field of the Invention

The present invention relates to a method and system for creating a person's age quotient and more specifically to using a computer to create a person's age quotient that repeatably and reliably defines and describes a person's physical and biological age Vs. his/her chronological age.

2. Description of Related Art

Method for identifying or recognizing peoples faces are known in the prior art. More specifically, by way of example, U.S. PreGrant Publication No. 20100246906 to Lovell; et al. discloses a person's face is captured by a computer. The computer estimates the orientation of the face and then, using a correlation model, the pose effect is removed from the image. Pattern recognition techniques are then applied to compare the pose independent features to a gallery stored in memory to match the face to a member of the gallery.

U.S. PreGrant Publication No. 20070071288 to Wu; et al discloses image processing technology to detect a face person by person. Then, the facial features for a plurality of persons are categorized into several categories to form a human facial features database for the plurality of persons and a recognized human face image of a person is inputted. Then, the image is acquired with positions of the person's face and facial features by image processing technology and each of the facial features is categorized into several categories where according to the categories which the facial features of the person belongs, the person may be recognized.

U.S. Pat. No. 7,221,809 to Geng discloses a method of automatically recognizing a human face includes developing a three-dimensional model of a face; and generating a number of two-dimensional images based on the three-dimensional model. The generated two-dimensional images are then enrolled in a database and searched against an input image to identifying the face of the input image.

U.S. Pat. No. 6,108,437 to Lin discloses a face recognition system having an input circuit, such as a video camera for generating an image of a person. A face detector circuit determines if a face is present in a image. A face position registration circuit determines a position of the face in the image if the face detector process or circuit determines that the face is present. A feature extractor circuit extracts at least two facial features from the face. A circuit compares the extractor facial features with a database to identify the face.

### SUMMARY OF THE INVENTION

In an exemplary embodiment of the present invention, there is disclosed a method of using a computer for providing an Age Quotient (AQ) which is similar to a FICO (credit worthiness) or IQ index that repeatably and reliably defines and describes a person's physical and biological age Vs. his/her chronological age comprises:

recording an image of each face of a multiple number of people;

assigning a reference numeral to each feature of a person's face;

grouping the reference numerals into specific areas of data;

using the data for each area to create a statistical model which includes a distribution curve normalized and cross correlated by a specific area of, for example, sex, race, ancestry, or genetics of each specific area;

comparing the distribution curve(s) with a person's profile to identify a distribution curve which places that person's individual's profile at the mathematically appropriate standard deviation from the normal distribution; and

assigning the center of the distribution curve to be the standard where chronological age is deemed to equal Somatic age.

In another exemplary embodiment of the present invention there is disclosed a method of using a computer for providing an Age Quotient (AQ) which is similar to a FICO (credit worthiness) or IQ index that repeatably and reliably defines and describes a person's physical and biological age Vs. his/her chronological age comprises:

recording non-macro/external features of a multiple number of people;

assigning a reference numeral to each feature recorded;

grouping the reference numerals into specific areas of data;

using the data for each area to create a statistical model which includes a distribution curve normalized and cross correlated by a specific area;

comparing the distribution curve(s) with a person's profile to identify a distribution curve which places that person's individual's profile at the mathematically appropriate standard deviation from the normal distribution; and

assigning the center of the distribution curve to be the standard where chronological age is deemed to equal Somatic age;

wherein the non-macro/external features include but are not limited to brachial blood pressures, ankle/brachial blood pressures, cholesterol levels, heart rates/profiles, grip strengths, skin flexibility.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of one of multiple images being taken of a person's face over a fixed interval of time to obtain an Age Quotient that repeatably and reliable defines and describes a person's physical and geological age vs. his/her chronological age;

FIG. 2 is a flow diagram of a method for obtaining an Age Quotient that repeatably and reliable defines and describes a person's physical and geological age Vs. his/her chronological age.

### DESCRIPTION OF THE PREFERRED EMBODIMENT

At the present time there is no quantifiable method which can be used to correlate a person's age based on his/her chronological age, date of birth, and their medical age based on that person's health, health related habits, life style, etc.

The present invention uses a multispectral image of the face of a person where an image of the face is recorded with an imaging device in a repeatable and fixed location such that all of the images of the faces are in the same relative location in space, and each image receives the same lighting. Each of the resulting images is then analyzed and a reference number is assigned to each surface and subsurface facial feature which is further identified as, but not limited to:

age spots and the location, depth, size, shape, clustering, color, reflectance, composition, intensity, and/or emergence/visibility of the age spots;

blemishes and the location, depth, size, shape, clustering, color, reflectance, composition, intensity, and/or emergence/visibility of the blemishes;

surface and subsurface vasculature patterns/geography and inflammation including their size, shape, clustering, color, reflectance, composition, intensity, and/or emergence/visibility;

pores and their location, depth, size, shape, clustering, color, reflectance, composition, intensity, and/or emergence/visibility;

teeth and the location, depth, size, shape, clustering, color, reflectance, composition, intensity, and/or emergence/visibility;

neck and its depth, size, shape, color, reflectance, and/or its composition;

fat deposits and their location, depth, size, shape, clustering, color, reflectance, composition, intensity, and/or emergence/visibility;

hair and its density, length, clustering, color, reflectance, composition and/or its color intensity;

wrinkles and their location, depth, size, shape, clustering, reflectance, intensity, and/or emergence/visibility;

hands and their size, shape, color, reflectance, and/or composition;

macro feature changes over time including but not limited to nose growth, mouth shape, feature migration, bone structure and topological changes;

sclera and other features of one or both eyes such as vascular changes.

Each of the above noted features are assigned a reference number both in relative and absolute terms and stored in databases which are then data mined across multiple individuals to create statistical models such as distribution curves which are normalized and cross correlated by such elements as sex, race, genetics, epigenetic, proteomic, ancestry and so on. The resulting distribution curves are then compared with an individual's scan/profile where such comparison results in placing the individual's profile at the mathematically appropriate standard deviation of, for example, from the normal distribution where the center of the bell shape curve is then assigned to be the standard where chronological age is deemed to equal the Somatic age. Then, standard deviations from the center of the bell shape curve which may be in combination with other mathematical and algorithmic operations will produce an Age Quotient or “AQ”. The AQ can be an overall AQ, and/or it can be broken into categories such as an AQ for wrinkles, an AQ for inflammation, and so on.

In practice, the AQ can guide medical research, inform the utility and efficacy of medical, dental and cosmetic interventions, guide clinical efforts and characterize the general progression of aging. Further, an AQ can have market value similar to a FICO (credit worthiness/quality) in that it can provide information to insurance companies for health and life by showing relative risk of disease and death for instance. Further, cosmetic and pharmaceutical companies can gain competitive and market advantage by being able to state objectively how their products affect typical and specific people in various categories such as, for example, race, sex, genotype, skin type, etc., AQ over time and with use.

The method disclosed provides standard reference points across the individuals in a category and by individuals. The method highlights, differentiates and records facial features and then assigns reference numerals to the results in a highly accurate, comprehensive and repeatable way. The method further recognizes each feature as a discrete element where a wrinkle becomes an entity in the same way that a river is a distinct feature on a map or a territory and is thus individually labeled, addressed, recognized, differentiated and measurable by chronological, pathological and geospatial characteristics. The reference numerals are then incorporated into a computerized, database which is normalized by dimensions such as race, genotype, sex, chronological age, current home location, etc., where statistical operations that ;produce the AQ can be conveniently performed.

To determine/derive the physical age or Age Quotient (AQ) based on the AQ STD deviation, simply find the cadre wherein a given face/score fits the center of that cadre's bell curve peak (zero STD deviation). For instance, if a person's face is a 1 STD deviation to the left of the person's cadre's (age, sex, race, et al.) centerline, then that fit would be overlaid onto matching younger cadre's curves until the best numerical peak bell curve fit within a younger cadre is found. If, for instance, the person's face is in the 66^{th} percentile, or AQ=100 of the 52^{nd} year old AQ group, then that “52” would be the person's biological AQ. Thus, with this invention all aesthetic judgments are no longer needed and the entire process can be automated.

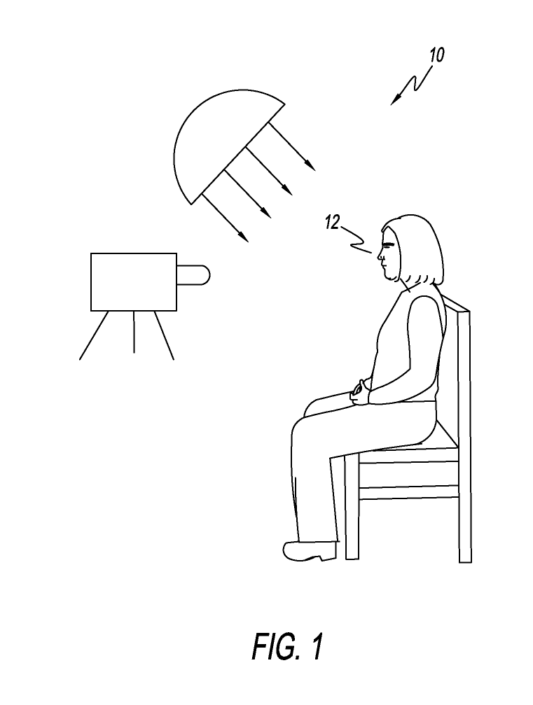

Referring to FIG. 1 there is shown a side view 10 of one of multiple images being taken of a person's face 12 over a fixed interval of time to obtain an Age Quotient that repeatably and reliable defines and describes a person's physical and geological age vs. his/her chronological age.

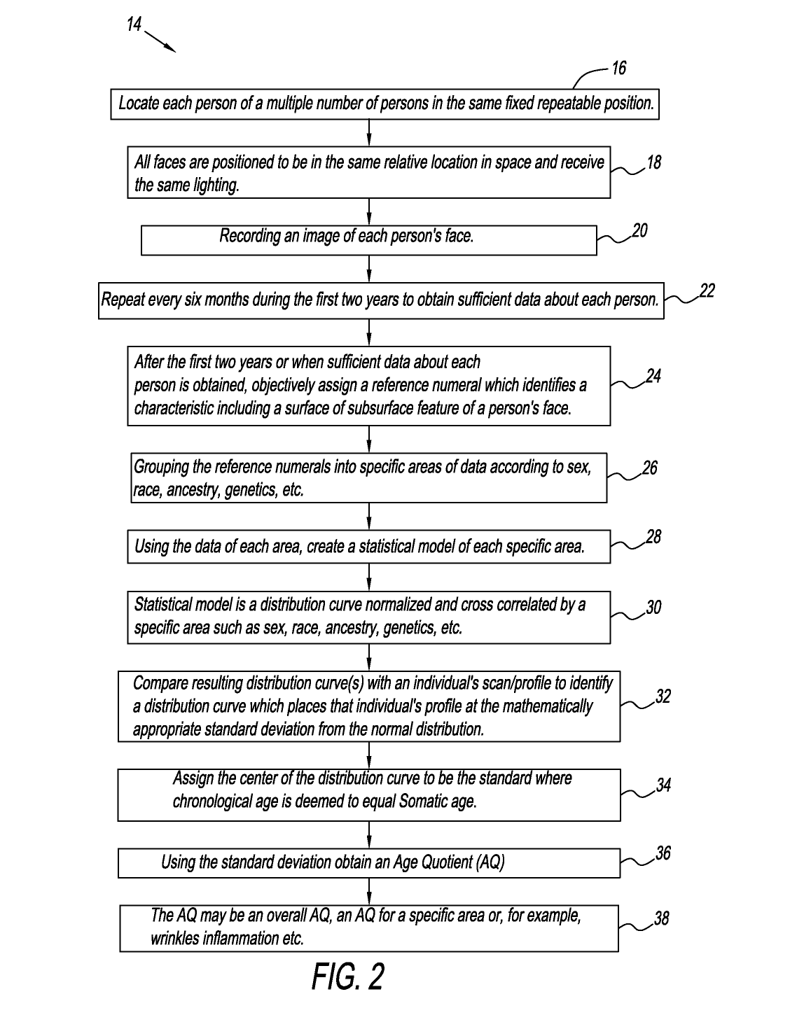

Referring to FIG. 2, there is shown a flow diagram 14 of a method for obtaining an Age Quotient that repeatably and reliable defines and describes a person's physical and geological age Vs. his/her chronological age.

The method may be performed in real time on a computer having application software installed to cause the computer to operate in accordance with the method. The computer system is comprised on a personal computer. The computer has memory to store the software and a processor to execute the method. The computer also has input means typical of a personal computer, such as a keyboard and a mouse.

Initially each person of a group of people is located in the same fixed repeatable position, block 16. The face of each person is positioned to be in the same relative location in space and receives the same lighting, block 18. An image is recorded of each person's face, block 20, and is repeated every six months during the first two years to obtain sufficient data about each person, block 22.

Thereafter, after the first two years or when sufficient data about each person has been obtained, a reference numeral is assigned which identifies a characteristic including a surface or subsurface feature of a person's face, block 24.

The reference numerals are grouped into specific areas of data according to sex, race, ancestry, genetics, etc., block 26. Using the data of each area, a statistical model of each specific area is created, block 28, where the statistical model is a distribution curve normalized and cross correlated by a specific area such as sex, race, ancestry, genetics, etc., block 30. The resulting distribution curve(s) is compared with an individual's scan/profile to identify a distribution curve which places that individual's profile at the mathematically appropriate standard deviation from the normal distribution, block 32, and the center of the distribution curve is assigned to be the standard where chronological age is deemed to equal Somatic age, block 34. At this time the Age Quotient (AQ) is obtained using the standard deviation, block 36. The AQ may be an overall AQ, an AQ for a specific area or, for example, wrinkles inflammation etc.; block 38.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of using a computer for providing an Age Quotient (AQ) which is similar to a FICO (credit worthiness) or IQ index that repeatably and reliably defines and describes a person's physical and biological age Vs. his/her chronological age comprises:
recording an image of each face of a multiple number of people in a computer;
assigning a reference numeral to each feature of a person's face;
grouping the reference numerals into specific areas of data;
using the data for each area to create a statistical model which includes a distribution curve normalized and cross correlated by a specific area of, for example, sex, race, ancestry, or genetics of each specific area;
comparing the distribution curve(s) with a person's profile to identify a distribution curve which places that person's individual's profile at the mathematically appropriate standard deviation from the normal distribution; and
assigning the center of the distribution curve to be the standard where chronological age is deemed to equal Somatic age.

2. The method of claim 1 wherein the reference numeral that is assigned to each feature of a person's face identifies a characteristic of the person's face.

3. The method of claim 2 wherein the characteristic includes a surface or subsurface feature of the persons face.

4. The method of claim 3 wherein the reference numerals which are grouped into specific areas of data are grouped according to sex, race, ancestry, genetics, etc.

5. The method of claim 4 wherein an Age Quotient is obtained using a standard deviation.

6. The method of claim 5 wherein the Age Quotient is an overall Age Quotient, an Age Quotient for a specific area, or an Age Quotient for wrinkles.

7. The method of claim 6 wherein an image of each face of the multiple number of people is recorded every six months during the first two years to obtain sufficient data about each person.

8. The method of claim 7 wherein an image of each face of the multiple number of people is recorded once each year after the first two years.

9. A system using a computer to provide an Age Quotient (AQ) which is similar to a FICO (credit worthiness) or IQ index that repeatably and reliably defines and describes a person's physical and biological age Vs. his/her chronological age comprising:
storing in a computer an image of each face of a multiple number of people;
providing a reference numeral for each feature of a person's face;
grouping the reference numerals into specific areas of data;
using the data for each area to create a statistical model which includes a distribution curve normalized and cross correlated by a specific area of, for example, sex, race, ancestry, or genetics of each specific area;
comparing the distribution curve(s) with a person's profile to identify a distribution curve which places that person's individual's profile at the mathematically appropriate standard deviation from the normal distribution; and
assigning the center of the distribution curve to be the standard where chronological age is deemed to equal Somatic age.

10. The system of claim 9 wherein the reference numeral that is assigned to each feature of a person's face identifies a characteristic of the person's face.

11. The system of claim 10 wherein the characteristic includes a surface or subsurface feature of the persons face.

12. The system of claim 11 wherein the reference numerals which are grouped into specific areas of data are grouped according to sex, race, ancestry, genetics, etc.

13. The system of claim 12 wherein an Age Quotient is obtained using a standard deviation.

14. The system of claim 13 wherein the Age Quotient is an overall Age Quotient, an Age Quotient for a specific area, or an Age Quotient for wrinkles.

15. The system of claim 14 wherein an image of each face of the multiple number of people is recorded every six months during the first two years to obtain sufficient data about each person.

16. The system of claim 15 wherein an image of each face of the multiple number of people is recorded once each year after the first two years.

17. A method of using a computer for providing an Age Quotient (AQ) which is similar to a FICO (credit worthiness) or IQ index that repeatably and reliably defines and describes a person's physical and biological age Vs. his/her chronological age comprises:
recording non-macro/external features of a multiple number of people in a computer;
assigning a reference numeral to each feature recorded;
grouping the reference numerals into specific areas of data;
using the data for each area to create a statistical model which includes a distribution curve normalized and cross correlated by a specific area;
comparing the distribution curve(s) with a person's profile to identify a distribution curve which places that person's individual's profile at the mathematically appropriate standard deviation from the normal distribution; and
assigning the center of the distribution curve to be the standard where chronological age is deemed to equal Somatic age.

18. The method of claim 17 wherein the non-macro/external features include but are not limited to brachial blood pressures, ankle/brachial blood pressures, cholesterol levels, heart rates/profiles, grip strengths, skin flexibility.
